(19) United States
(12) Patent Application Publication
(10) Pub. No.: US 2009/0209206 A1
(43) Pub. Date: Aug. 20, 2009

(54) OPTIMAL MIMO ISI CHANNEL ESTIMATION USING LOOSELY SYNCHRONIZED CODES AND THEIR VARIATIONS

(75) Inventors: Xiang Zou, Durham, NC (US); Wai Ho Mow, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/032,303

(22) Filed: Feb. 15, 2008

(51) Int. Cl. H04B 7/00

(52) U.S. Cl. 455/59

(57) ABSTRACT

A training-based channel estimation technique is provided to estimate channel state information for MIMO systems that is highly energy efficient and optimal in terms of Cramér-Rao lower bound (CRLB). The technique employs loosely synchronized (LS) codes or shifted LS codes. The codes can be generated using a fast Golay correlator and an efficient Golay correlator. A low-complexity implementation is also provided.

### TECHNICAL FIELD

The subject disclosure relates generally to wireless communications systems, and more particularly to channel estimation in multiple-input multiple-output (MIMO) systems.

### BACKGROUND OF THE INVENTION

Wireless communication networks are increasingly popular and widely deployed. Multiple-input multiple-output (MIMO) technology is a promising candidate for next-generation wireless communications. Accurate channel state information (CSI) estimation is desirable in order to take advantage of the potential MIMO capacity. In particular, with accurate CSI estimation, CSI can be exploited for optimum or quasi-optimum precoder and equalizer designs with the purpose of maximizing system performance.

Thus, a number of CSI estimation schemes have been developed. These schemes generally are categorized as blind estimation or training-based estimation. Compared with blind estimation, the training-based estimation is more prevalent for its relatively simple implementation and better performance. One example of a training-based estimation is a shifted Golay complementary sequences (GCS) approach for zero-padding OFDM MIMO systems. Although shifted GCS can be optimal in terms of Cramér-Rao lower bound (CRLB), due to the many zeros contained in the GCS, shifted GCS leads to a low energy efficiency in terms of training overhead and a detrimental high peal-to-average power ratio (PAPR). Both of these undesirable effects, drastically deteriorates the performance of the wireless communication systems.

The above-described deficiencies of wireless network communications are merely intended to provide an overview of some of the problems of today's wireless networks, and are not intended to be exhaustive. Other problems with the state of the art may become further apparent upon review of the description of various non-limiting embodiments that follows.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to one aspect, a method of estimating channel state information is provided using loosely synchronized (LS) codes as training sequences in a MIMO network, such as an MIMO intersymbol interference (ISI) network. Sequences are appended as a preamble and postamble to a frame comprising the training sequences. Once the training sequences are received by a MIMO receiver (e.g., a base station or access point), they are used to estimate the current CSI. The training can be done periodically to keep the estimated CSI reasonably updated.

According to another aspect, a method of estimating channel state information is provided using shifted LS codes as training sequences. While the shifted LS codes may not provide optimal energy efficiency compared to LS codes, they can be useful in a number of MIMO usage scenarios.

Either LS codes or shifted LS codes provide high energy efficiency while at the same time achieving the Cramér-Rao lower bound (CRLB). The method can be implemented in one aspect as a low-complexity estimator that uses both an efficient Golay correlator (EGC) and a fast Golay correlator (FGC) to facilitate the estimation. The estimated CSI can be subsequently used to perform precoding or determine equalizer coefficients.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a diagram of an exemplary multiple-input multiple-output (MIMO) wireless communication network in which the aspects can be implemented.

FIG. 2 is a diagram of an exemplary frame structure according to one aspect.

FIG. 3 is a low complexity estimator according to one embodiment.

FIG. 4 is a graph of normalized minimum square error (MSE) for various L values according to one embodiment.

FIG. 5 is a graph of training length Nₜᵣ for various L values according to one embodiment.

FIG. 6 is a graph of energy efficiency of training sequence for various L values according to one embodiment.

FIG. 7 is a block diagram of a MIMO receiver according to one embodiment.

FIG. 8 is a flowchart of a method of channel estimation and usage of the estimated channel state information (CSI) in accordance with an aspect of the present invention.

FIG. 9 is a flowchart of a method of a MIMO transmitter transmitting a training sequence and receiving a coding scheme in accordance with one aspect.

FIG. 10 is a block diagram representing an exemplary non-limiting computing system in which the claimed subject matter can be implemented.

FIG. 11 is a diagram of a network environment in which the claimed subject matter can be implemented.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

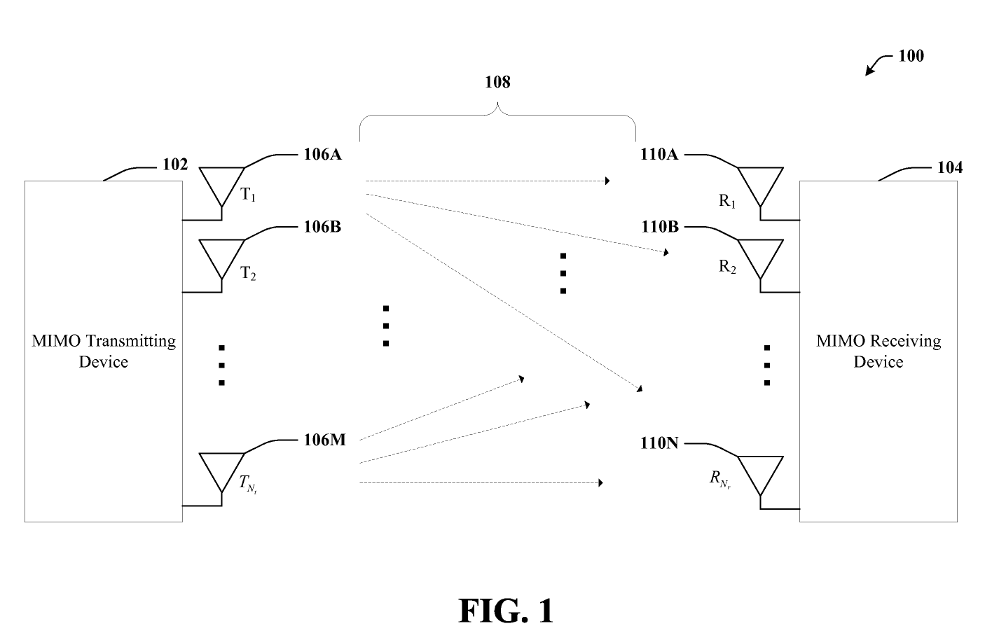

Turning to FIG. 1, an exemplary operating environment 100 is illustrated. In particular, a MIMO transmitting device 102 and a MIMO receiving device 104 are illustrated. The MIMO transmitting device 102 has Nₜ transmitting antennas (106A, 106B . . . 106M). Each transmitting antenna sends data over channel 108 to Nᵣ receiving antennas (110A, 110B, 110N). Although for the sake of clarity the MIMO receiver and MIMO transmitter (and their associated antennas) are illustrated and described as receiving transmissions and transmitting transmissions, one skilled the art will appreciate that a single device with an array of antennas can acts as both a MIMO receiver 104 and a MIMO transmitter 102.

The following notations are adopted. Boldface is applied to vectors and matrices. [A]_{i,j} is the (i,j)^{th} element in matrix A. ∥·∥_{F} is the Frobenius norm. E{·} represents the mathematical expectation and ┌x┐ is the smallest integer not less than x. For a sequence a, a(z) is its z-transform while ã denotes its reflection. The operator [a]ₛ^{c} denotes cyclically shifting the sequence to the right by s elements. And the energy efficiency factor for a binary sequence a is denoted as η, which is the ratio of number of nonzero symbols to the training sequence length Nₜᵣ.

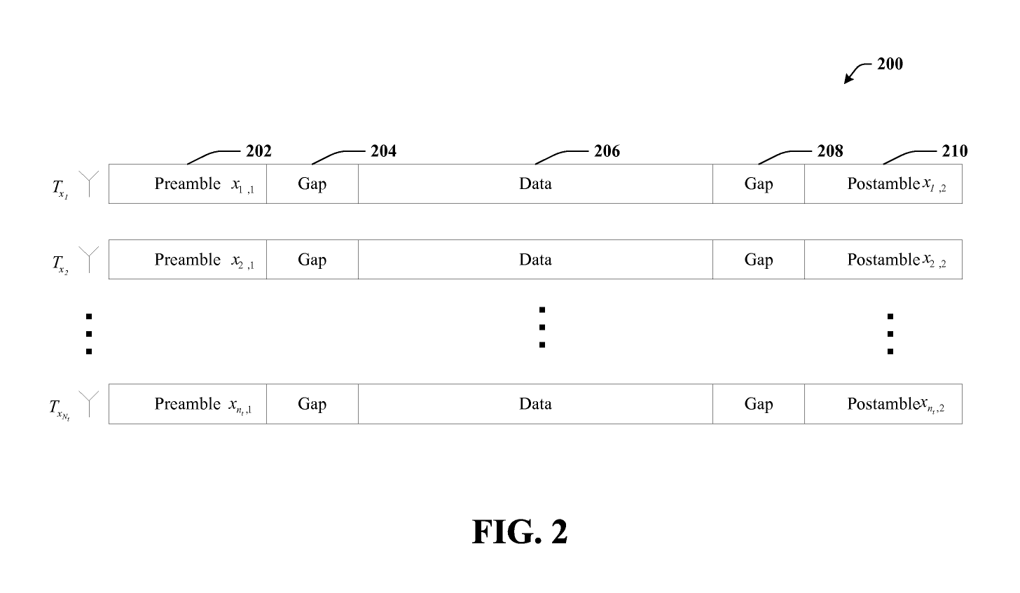

A two-side training scheme with both preamble and postamble allows for simple training sequence construction. Without the loss of generality, a MIMO ISI model will be used as an exemplary MIMO model. However, one skilled in the art will appreciate that the channel estimation technique disclosed herein can apply to many MIMO wireless application scenarios. In order to avoid the interference between data and training blocks in a MIMO ISI model, L 0's are needed to separate the data and training symbols. The frame structure 200 is depicted in FIG. 2 where the vectors xₙ_{ₜ}_{,1} and xₙ_{ₜ}_{,2} denote the preamble 202 and postamble 210 sequences, respectively, for transmitting antenna Nₜ. Data 206 can optionally be transmitted in the frame with gaps (204, 208) comprising L 0's separating the data and training symbols. Suppose N_{T} transmit and N_{R} receive antennas are employed for transmission in a MIMO system with SNR ρ, the corresponding multiple channel model is given by

[Y₁ Y₂]=\sqrt{ρ/N_{T}}H[X_{t,1} X_{t,2}]+[E₁ E₂] (Equation 1)

with the maximum channel dispersion delay being L and the channel information response (CIR) matrix being H=[H₀, H₁, . . . , H_{L}], where [Hₗ]_{i,j}=hₙ_{ᵣ}_{,n}_{ₜ} (l) is the CIR between the receiver antenna nᵣ and transmit antenna nₗ. The indices [·]₁ [·]₂ refer to the preamble and postamble parts, whose lengths are Nₜᵣ and their noise terms are mutually independent. For the sake of simplicity, it is also assumed that each subchannel is normalized to have unit power, i.e., Σₗ₌₀^{L} E{|hₙ_{ᵣ}_{,n}_{ₜ} (l)|²}=1, ∀nᵣ,nₜ. The elements X_{t,1},X_{t,1} are block-Toeplitz training matrices.

Sequences that meet the orthogonal condition X_{t,1}X_{t,1}^{T}+X_{t,2}X_{t,2}^{T}∝I_{N}_{_{T}}_{(L+1)} can have optimal performance in terms of minimum square error(MSE), or attain the Cramér-Rao lower bound (CRLB). However, some sequences satisfying this condition alone can not be practically used in most communication systems. For example, impulse sequences can be regarded as a special case of GCS, however, their extremely low energy efficiency is not acceptable for most situations (e.g., where MIMO devices are portable apparati that operate on battery power). Therefore, the energy efficiency should be taken into account in order to construct training sequences given practical constraint. η and 1/Nₜᵣ≦η≦1 reaches its minimum value when impulse sequences are adopted. Thus, it is desirable to construct training sequences such that both optimal MSE performance and high energy efficiency can be achieved simultaneously. According to the orthogonal condition, the maximum likelihood estimation (MLE) for channel matrix H can be simplified to

$$\hat{H} = \frac{\sqrt{{N}_{T}}}{2 η {N}_{tr} \sqrt{ρ}} {\sum }_{k = 1}^{2} {Y}_{n} {X}_{t , k}^{T} \qquad ( Equation 2 )$$

Based on the linear model in Equation 1 and Gaussian noise assumptions, Equation 2 attains the CRLB and its total MSE is:

$$E \{ {‖ H - \hat{H} ‖}_{F}^{2} \} = \frac{{N}_{T}^{2} {N}_{R} ( L + 1 )}{2 η ρ {N}_{tr}} \qquad ( Equation 3 )$$

Loosely synchronized (LS) codes were first used as a technology behind the LAS-CDMA system. For n=0,1,2, . . . , an LS code LSⁿ={LS₀ⁿ,LS₁ⁿ, . . . ,LS₂_{ⁿ⁺¹}₋₁ⁿ} of length 2ⁿ⁺¹N+N−1 comprises 2ⁿ⁺¹ LS code sequences. Each LS code sequence is a ternary code composed by concatenating its C component cᵢⁿ and S component sᵢⁿ, both of which are ±1 valued binary sequences of length 2ⁿ N, separated by at least N−1 zeros. One feature of LS code is that its sequences are not only zero-con-elated with itself except at the origin but also mutually zero-correlated with any other sequence, only if the correlation shifts are within the zero correlation zone (ZCZ) range, or mathematically:

R_{LS}_{ᵢ}_{ⁿ}_{,LS}_{ⱼ}_{ⁿ}(τ)=0, 0<|τ|<N or (τ=0,i≠j) (Equation 4)

cᵢⁿ and sᵢⁿ can be generated in one aspect from two uncorrelated Golay complementary sequence pairs (C1,S1)=(a₀,ã₁) and (C2,S2)=(a₁,−ã₀) in a recursive procedure. All of these sequences are of length N=2^{m}, m≧1 and (a₀,a₁), (ã₀,ã₁) can be generated, for example, by a fast Golay correlator (FGC) and an efficient Golay correlator (EGC), respectively. The resulting LS code has a ZCZ of N=2^{m}. LSⁿ reduces to uncorrelated GCS pairs when n=0.

Using the zero correlation property of LS code, a training scheme is constructed having two training matrices conforming to the orthogonal condition. C and S-component are allocated from a LS code sequence as the preamble and postamble for each transmit antenna. As demonstrated in the following, the parameters of applicable LS code are determined by particular MIMO system parameters.

Consider a system with N_{T} transmit antennas and L as the maximum dispersion delay. In order to have different sequences to allocate, the number of available code sequences should be equal or greater than N_{T}, namely, 2ⁿ⁺¹≧N_{T} or n=┌log₂ N_{T}┐−1. In order to have Equation 4 hold, the maximum channel dispersion L should not exceed the ZCZ of LS code, namely, L≦N−1=2^{m}−1, which is equivalent to m=┌log₂(L+1)┐+Δ,Δ≧0. The integer factor Δ is defined as the training strength and training sequences with minimum length are those with Δ=0.

With the above derived LS code, the training symbol assignment is given by (xₙ_{ₜ}_{,1},xₙ_{ᵣ}_{,2})=(cₙ_{ₜ}₋₁ⁿ,sₙ_{ₜ}₋₁ⁿ) for transmit antenna nₜ ε [1,N_{T}]. Since both C and S components are packed with nonzero symbols ±1 only, equivalently, η=1, along with the ZCZ property in Equation 4, the training assignment meets the orthogonal condition aforementioned and has optimal MSE performance.

The core of shifted GCS approach lies in appending 0's to the beginning or end or both sides of the GCSs and shifting the zero appended sequences. These manipulations on the original GCS retain their previous correlation properties and offer more available sequence pairs. Applying similar manipulations to LS code results in a shifted LS code approach, which offers an alternative scheme.

Suppose pair (cₖⁿ,sₖⁿ) is the C and S-component of sequence LSᵢⁿ from LSⁿ with ZCZ of N=2^{m}. If p(L+1) zeros are introduced to pad the cᵢ^{k} or sᵢ^{k} and shift operations are applied to them, the original LS code can be expanded with 2ⁿ⁺¹ sequences into a larger code set with (p+1)2ⁿ⁺¹ sequences, where p≧0 is called the extension factor. Ternary pair vectors ([cₖⁿ,0_{1×p(L+1)}],[sₖⁿ,0_{1×p(L+1)}]), k ε [0,2ⁿ⁺¹−1] each have a length of Nₜᵣ=2ⁿN+p(L+1). Then, a set of shifted LS code pairs are constructed as follows:

(mᵢ,nᵢ)=([cₖⁿ,0_{1×p(L+1)}]_{j(L+1)}^{c},[sₖⁿ,0_{1×p(L+1)}]_{j(L+1)}^{c}) (Equation 5)

where i=k+j2ⁿ⁺¹ and k ε [0,2ⁿ⁺¹−1], j ε [0,p], i ε [0,(p+1)2ⁿ⁺¹−1]. Like the LS code approach, system parameters L,N_{T} and the orthogonal condition both impose constraints on the parameters of shifted LS code. First, 2ⁿ⁺¹(p+1)≧N_{T} can be satisfied to have enough sequences for all transmit antennas. Second, the pairs of those sequences should have sufficiently large ZCZ to accommodate the maximum channel dispersion. General LSⁿ code (n>0) has its ZCZ smaller than the total sequence length. And the shifted LS code construction in Equation 5 has already introduced an extra p(L+1) shift besides the L+1 shift brought by the channel dispersion. Therefore, the ZCZ of the original general LSⁿ code meets N≧(p+1)(L+1). However, the ZCZ of GCS pairs (LS⁰) is equal to its sequence length. This implies that the resulting shifted GCS pairs still have the properties specified in Equation 4 even if the shift τ is beyond sequence length. Consequently, the orthogonal condition for shifted LS code generated from GCS pairs occurs no matter what the length of original GCS is. These constraints can be rewritten as parameters of (n,m) for shifted LS code in a mathematical way:

$$\begin{matrix}n = ⌈ {log}_{2} {N}_{T} - {log}_{2} ( p + 1 ) ⌉ - 1 , 0 \leq p \leq ⌈ {N}_{T} / 2 ⌉ - 1 & ( Equation 6 ) \\ m = \{ \begin{matrix}⌈ {log}_{2} ( L + 1 ) ⌉ + Δ & n = 0 \\ ⌈ {log}_{2} ( ( p + 1 ) ( L + 1 ) ) ⌉ + Δ & n \geq 1\end{matrix} & ( Equation 7 )\end{matrix}$$

The training symbols assignment based on shifted LS code pairs (mᵢ,nᵢ) can be (xₙ_{ₜ}_{,1},xₙ_{ₜ}_{,2})=(mₙ_{ₜ}₋₁ⁿ,nₙ_{ₜ}₋₁ⁿ) for transmit antenna nₜ ε [1,N_{T}]. Consider the two extreme cases for p=0 and ┌N_{T}/2┐−1. When p is maximized, n=0 from Equation 6. For the n=0 case, the code pairs are simply the shifted GCS. When p is minimized, no 0's are contained in the training sequences, which are identical to the LS code. In summary, once the system parameters N_{T} L are fixed, a suitable training code can be constructed with parameters (m,n,p) by choosing appropriate training strength order Δ (adjusting the training length) and extension factor p (determining the code class) based on Equation 6 and 7.

For training sequences based on shifted LS code characterized by parameters (m,n,p), a matrix Hₙ_{ᵣ} is defined of dimension 2ⁿ⁺¹×(p+1)(L+1), whose i^{th} row is given by [hₙ_{ᵣ}_{,i},hₙ_{ᵣ}_{,2}_{ⁿ⁺¹}₊ᵢ, . . . ,hₙ_{ᵣ}_{,p2}_{ⁿ⁺¹}₊ᵢ], i ε [1,2ⁿ⁺¹],hₙ_{ᵣ}_{,n}_{ₜ}=(hₙ_{ᵣ}_{,n}_{ₜ}(0), . . . ,hₙ_{ᵣ}_{,n}_{ₜ}(L)). Matrix Hₙ_{ᵣ} includes all the subchannel coefficients between the nᵣ^{th} receive antenna and the N_{T} transmit antennas. Then, Equation 2 can be rewritten as:

$${\hat{H}}_{{n}_{r}} = \frac{\sqrt{{N}_{T}}}{2 η {N}_{tr} \sqrt{ρ}} {\sum }_{i = 1}^{2} {S}_{t} {Y}_{{n}_{r} , t} \qquad ( Equation 8 )$$

In the above equation, S₁=[c₀ⁿ^{^{T}},c₁ⁿ^{^{T}}, . . . ,c₂_{ⁿ⁺¹}₋₁^{n T}]^{T}, S₂=[s₀ⁿ^{^{T}},s₁ⁿ^{^{T}}, . . . ,s₂_{ⁿ⁺¹}₋₁^{n T}]^{T} and Yₙ_{ᵣ}_{,t} is of dimension 2ⁿ N×(p+1)(L+1) with its i^{th} row defined as [yₙ_{ᵣ}_{,t}(i−1),yₙ_{ᵣ}_{,t}(i), . . . ,yₙ_{ᵣ}_{,t}(Nₜᵣ+L−2ⁿ N+i−1)]. The element yₙ_{ᵣ}_{,t}(k) corresponds to the received signal by the nᵣ^{th} antenna at time k during preamble and postamble periods, k=1, 2, respectively. The (p+1)(L+1) elements in the i^{th} row of matrix [S₁Yₙ_{ᵣ}_{,1}] can be viewed as the middle part of outputs (discarding the first and last 2ⁿ N elements) of a FIR filter with impulse response as \tilde{c}\tilde{cᵢ₋₁ⁿ} and input as the received vector yₙ_{ᵣ}_{,1}=[yₙ_{ᵣ}_{,1}(0),yₙ_{ᵣ}_{,1}(1), . . . ,yₙ_{ᵣ}_{,1}(Nₜᵣ+L−1)]during the preamble period. And the overall rows of [S₁Yₙ_{ᵣ}_{,1}] can be calculated by feeding yₙ_{ᵣ}_{,1} to a FIR filter bank whose impulse responses are \tilde{c}₀ⁿ,\tilde{c}₁ⁿ, . . . ,\tilde{c}₂_{ⁿ⁺¹}₋₁ⁿ. Using z-transform, the reflected sequence \tilde{c}ᵢⁿ is related with the C-component cᵢⁿ through \tilde{c}ᵢⁿ(z)=cᵢⁿ(z⁻¹)z^{-(N2}^{ⁿ}⁻¹⁾, where N=2^{m}. Based on the recursive generation method of cᵢⁿ, this filter bank can be implemented in a similar recursive manner:

\tilde{c}₄ᵣⁿ(z)=\tilde{c}₂ᵣ₊₁ⁿ⁻¹(z)+ĉ₂ᵣⁿ⁻¹(z)z^{-N2}^{^{n−1}}

\tilde{c}₄ᵣ₊₁ⁿ(z)=\tilde{c}₂ᵣ₊₁ⁿ⁻¹(z)−\tilde{c}₂ᵣⁿ⁻¹(z)z^{-N2}^{^{n−1}} (Equation 9)

\tilde{c}₄ᵣ₊₂ⁿ(z)=\tilde{c}₂ᵣⁿ⁻¹(z)+\tilde{c}₂ᵣ₊₁ⁿ⁻¹(z)z^{-N2}^{^{n−1}}

\tilde{c}₄ᵣ₊₃ⁿ(z)=\tilde{c}₂ᵣⁿ⁻¹(z)−\tilde{c}₂ᵣ₊₁ⁿ⁻¹(z)z^{-N2}^{^{n−1}}

where i =0,1, . . . ,2ⁿ⁻¹−1. The recursion begins from \tilde{c}\tilde{c₀⁰}(z)=ã₀(z),\tilde{c}\tilde{c₁⁰}(z)=ã₁(z), both of which can be generated efficiently with EGC 304. In a similar manner, the elements of [S₂Yₙ_{ᵣ}_{,2}] can be computed with another filter bank using yₙ_{ᵣ}_{,1} as input and beginning the recursion based on \tilde{s}\tilde{s₀⁰}(z)=a₁(z),\tilde{c}\tilde{c₁⁰}(s)=−a₀(z), generated from FGC 302. Eventually, Ĥₙ_{ᵣ} is attained by adding the corresponding output elements of two filter banks followed by a scaling operation.

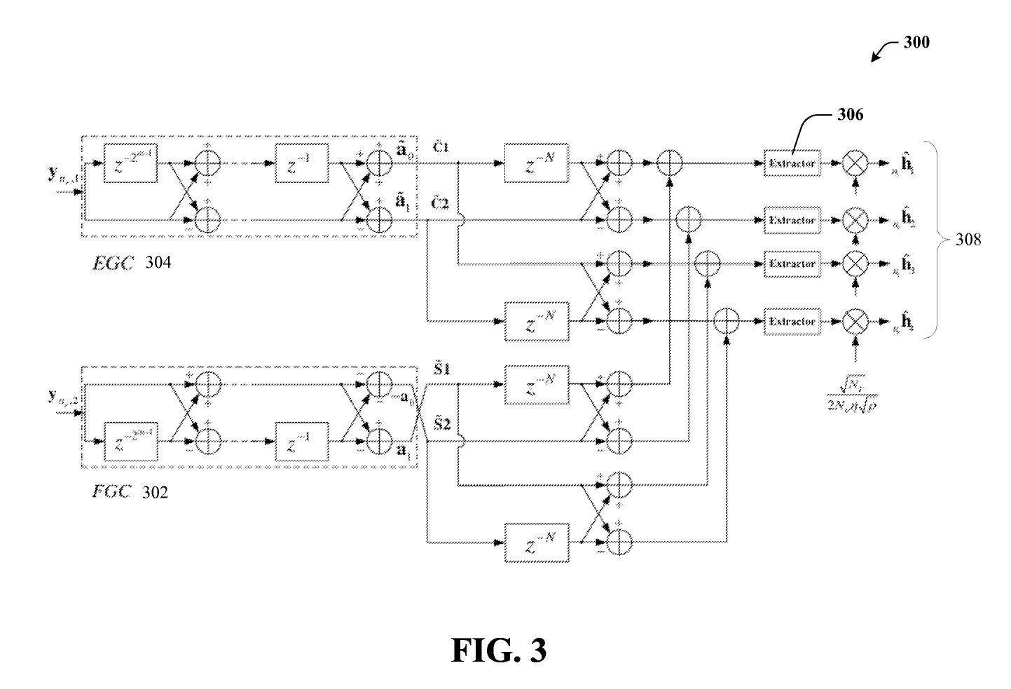

If the number of total transmit antennas N_{T}<2ⁿ⁺¹(p+1), the estimator outputs hₙ_{ᵣ}_{,j}, j>N_{T} are treated as junk information by discarding them, since they contain no information on CIR. The implementation of a low-complexity estimator according to one embodiment is illustrated in FIG. 3 for n=1 case. The four outputs of its estimator ₙ_{ᵣ}ĥᵣ, r ε [1,2ⁿ⁺¹], n=1 correspond to the rows of The 4-row matrix Ĥₙ_{ᵣ}. And only one stage recursion can be involved to construct the filter banks where 4 delay lines with N2ⁿ⁻¹ (N in FIG. 3) delays are utilized. The extractors 306 discard the first and last 2ⁿ N—in this example, 2N, which is not shown in FIG. 3—elements and retain the middle parts.

The estimator 300 for shifted LS code with parameters (m,n,p) needs 4m+10·2ⁿ−8 adders and 2m+2ⁿ⁺²−6 delay components. Both m and n are related with training strength Δ and extension factor p through Equations 6 and 7. The complexity comparison is left in the next section.

The comparisons below are for a MIMO system with N_{T}=5 transmit antennas and signal to noise (SNR) ρ=1. The extension factor p=0,1,2 corresponds to the shifted GCS, general shifted LS and LS code approach, respectively.

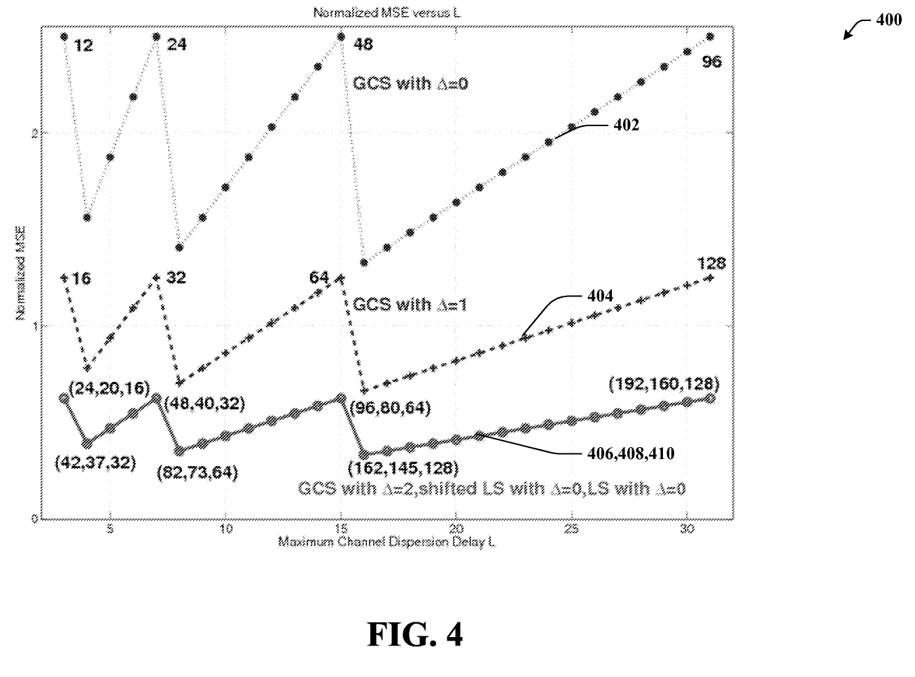

In practice, good system performance is achieved by small estimation MSE. In FIG. 4, the performance is evaluated by the total MSE in Equation 3, normalized by E∥H∥_{F}²=N_{T}N_{R}. The normalized MSE is influenced by both training code class (determined by p) and training length Δ. Referring to FIG. 4, for shifted GCS code (p=0), larger Δ produces better MSE performance, corresponding to a lower curve. This improvement is made at the sacrifice of longer training length, which are indicated by the increasing numbers as Δ increases from 0 to 2 for L=3,7,15,31. The performance curves for GCS (Δ=2) (curve 406) and shifted LS code (Δ=0) (curve 408) and LS code (Δ=0) (curve 410) overlap, suggesting that these training codes have the same MSE performance. However, the LS code approach has the smallest Nₜᵣ while the GCS has the largest one as suggested by the size in the parenthetical triplets.

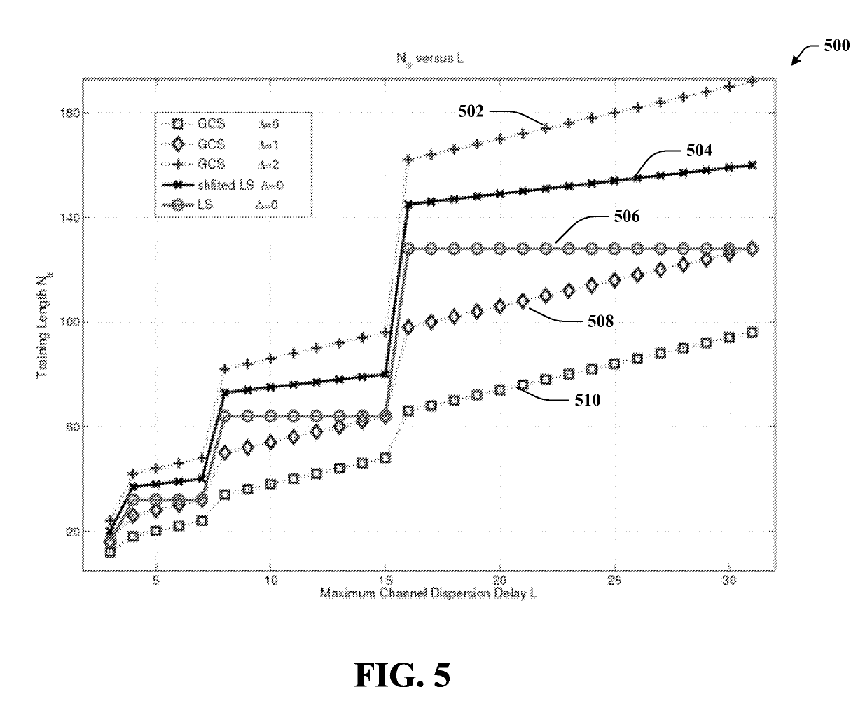

Another quantity of interest is the system overhead, characterized by the training length Nₜᵣ. It is also determined by both the code class and training length. Nₜᵣ in relation to various L are plotted in FIG. 5. The Nₜᵣ of training sequences based on LS code (curve 506) can only take values of 2-power numbers, while shifted LS (curve 504) and GCS code (curves 502, 508, and 510) allow more flexible choices on Nₜᵣ. FIG. 5 again confirms that LS code has the shortest length but the same performance in comparison with the other two codes in terms of MSE.

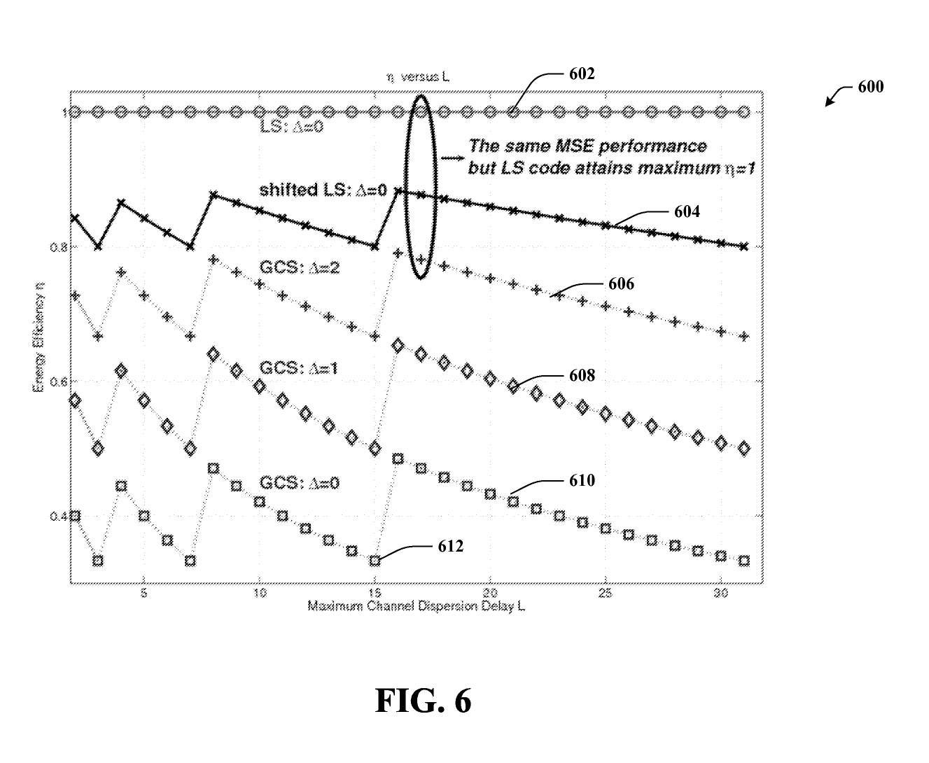

Moreover, the energy efficiency factor η of training sequence, being equivalent to the reciprocal of PAPR for binary code, is of concern in most applications. η is depicted for different L values in FIG. 6. Sequences based on LS code (curve 602) keep the maximum value 1, whose curve appears on the top of all other code curves (curves 604, 606, 608, 610, and 612). For the same Δ, GCS code has a lower η value in comparison with that of shifted LS code. Although η for GCS approach can be improved by reinforcing training strength, it is at the expenses of a prolonged Nₜᵣ. And worst of all, η for GCS approach never reaches the maximum value 1 as it can in the LS approach. Shifted LS code has a slightly larger η compared with the GCS approach, which is acceptable in some usage scenarios.

So far N_{T}>8 is unlikely in applications where a maximum of n=3 recursion stage is enough. Thus, the complexity of the estimator according to one embodiment is low since the exponential terms are confined in the number of adders and delay components. Consider the three approach with equivalent performance: GCS with Δ=2, shifted LS and LS both with Δ=0. The complexity in terms of adder number is ┌log₂(L+1)┐+12,+16,+32 and ┌log₂(L+1)┐−2,+4,+10 in terms of delay components. However, the complexity entailed by using LS code is almost trivial for modem very large scale integration (VLSI) technology.

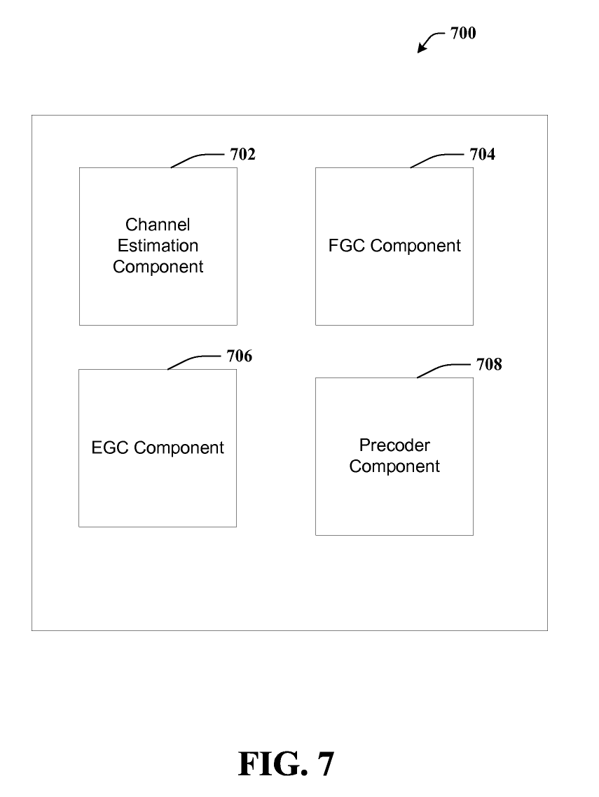

FIG. 7 illustrate components of a MIMO network interface 700 according to one embodiment. For the sake of clarity, other hardware or software components traditionally associated with a MIMO receiver (e.g., receiving antennas) are not shown and described. However, one skilled in the art will appreciate that these additional hardware or software components can be present.

A channel estimator component 702 estimates the CSI. In particular, the component can receive training signals from one or more MIMO user devices. The received signals can be used to estimate the CSI using the described LS and shifted LS codes. For example, the FCG component 704 and the ECG component 706 can be used in connection with the channel estimator component to create the low-complexity estimator illustrated in FIG. 3. In particular, the FCG component 704 performs fast Golay correlation and the EGC component similarly performs efficient Golay correlation. The precoder component 708 can then use the estimated CSI to determine a coding scheme. Although not shown, one skilled in the art will appreciate the estimated CSI can be used for other purposes, such as to determine equalizer coefficients.

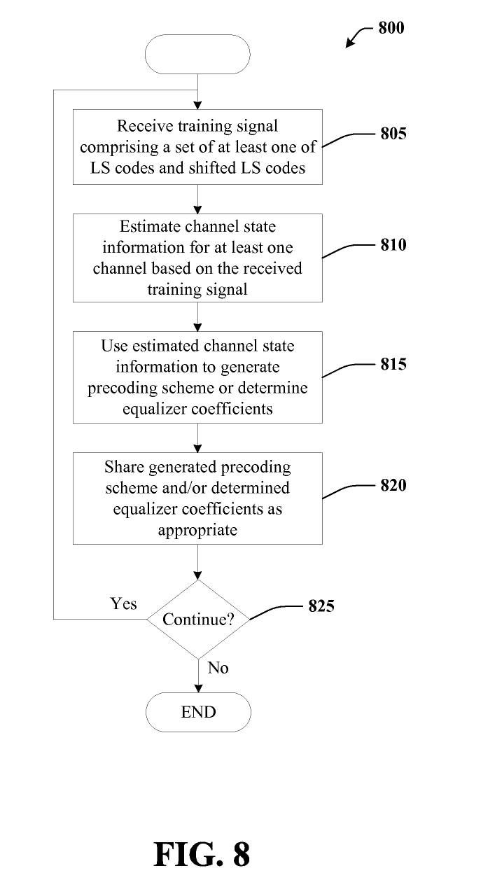

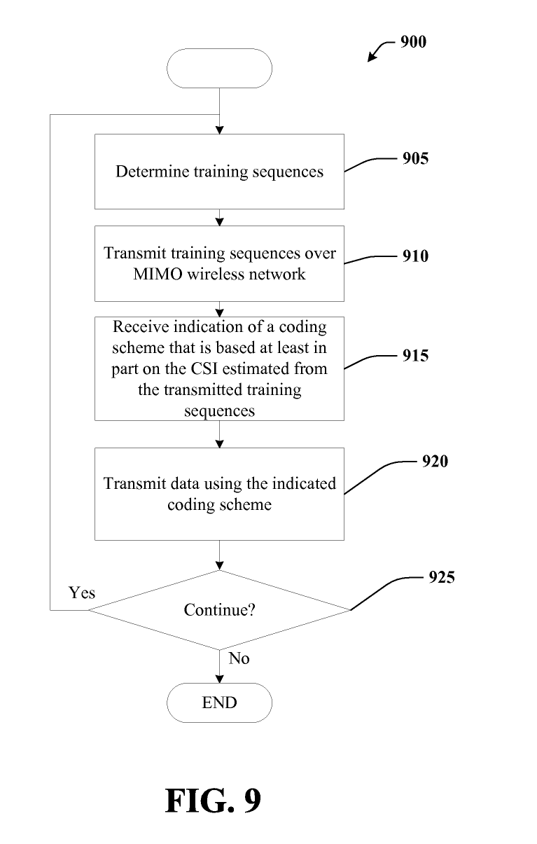

Turning briefly to FIGS. 8 and 9, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

Referring to FIG. 8, a method 800 in a MIMO device (e.g., an access point, base station) according to one embodiment. At 805, a training signal is received comprising a set of at least one of LS codes or shifted LS codes. At 810, channel state information for at least one channel based on the received training signal. At 815, the estimated CSI is used to generate a preceding scheme (e.g., STBC) or to determine equalizer coefficients. At 820, the generated precoding scheme and/or the determined coefficients is shared as appropriate. For example, the preceding can be shared with other devices connected to the MIMO network. At 825, the method determined whether to continue and if so returns to 805 to receive a new training sequence that can result in updating the estimated CSI.

Referring to FIG. 9, a method 900 in a MIMO device according to one embodiment. At 905, a training sequence is determined. At 910, the training sequence is transmitted from each of the transmitting antennas over the wireless network. At 915, an indication of a coding scheme that is based on the CSI estimated from the training sequence is received. At 920, data can be transmitted using the coding scheme. Advantageously, the data transmission can be limited to a predetermined time period before the CSI needs to be updated. At 925, the method determines whether to continue and if so proceeds to 905.

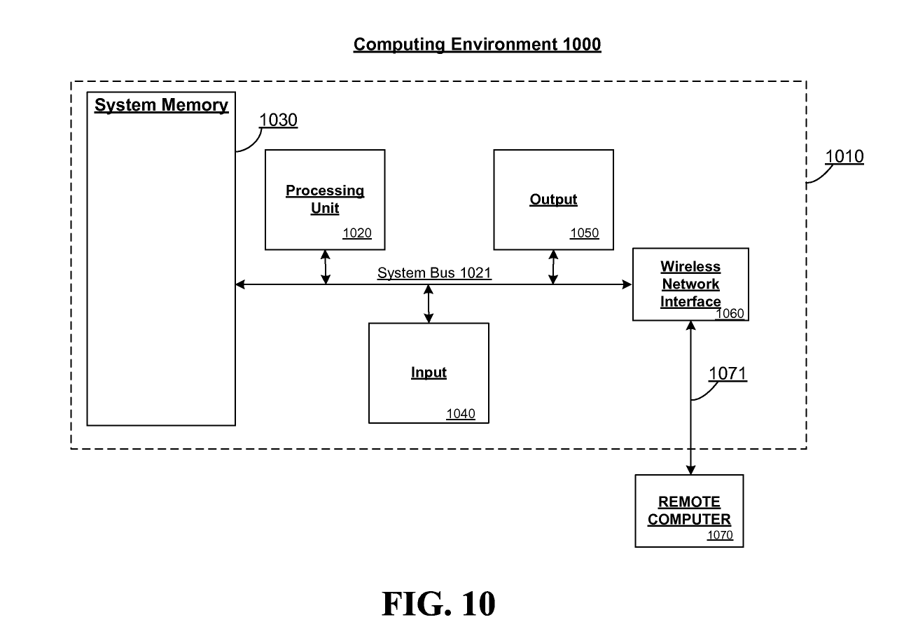

Turning to FIG. 10, an exemplary non-limiting computing system or operating environment in which the present invention may be implemented is illustrated. One of ordinary skill in the art can appreciate that handheld, portable and other computing devices and computing objects of all kinds are contemplated for use in connection with the present invention, i.e., anywhere that a wireless communications system may be desirably. Accordingly, the computer described below in FIG. 10 is but one example of a computing system in which the present invention may be implemented.

Although not required, the invention can partly be implemented via software (e.g., firmware). Software may be described in the general context of computer-executable instructions, such as program modules, being executed by one or more computers.

FIG. 10 thus illustrates an example of a computing device in a wireless communication network. Those skilled in the art will appreciate that the invention may be practiced with any suitable computing system environment 1000 in which the invention may be implemented but the computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment 1000.

With reference to FIG. 10, an example of a computing device for implementing the invention includes a general purpose computing device in the form of a computer 1010. Components of computer 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures.

Computer 1010 typically includes a variety of computer readable media. Computer readable media can be any available media that can be accessed by computer 1010. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media typically embodies computer readable instructions, data structures, program modules or other data in a modulated data signal such as a carrier wave or other transport mechanism and includes any information delivery media.

The system memory 1030 may include computer storage media in the form of volatile and/or nonvolatile memory such as read only memory (ROM) and/or random access memory (RAM). A basic input/output system (BIOS), containing the basic routines that help to transfer information between elements within computer 1010, such as during start-up, may be stored in memory 1030. Memory 1030 typically also contains data and/or program modules that are immediately accessible to and/or presently being operated on by processing unit 1020. By way of example, and not limitation, memory 1030 may also include an operating system, application programs, other program modules, and program data.

The computer 1010 may also include other removable/non-removable, volatile/nonvolatile computer storage media. For example, computer 1010 could include a flash memory that reads from or writes to non-removable, nonvolatile media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, digital versatile disks, digital video tape, solid state RAM, solid state ROM and the like.

A user may enter commands and information into the computer 1010 through input devices. Input devices are often connected to the processing unit 1020 through user input 1040 and associated interface(s) that are coupled to the system bus 1021, but may be connected by other interface and bus structures, such as a parallel port, game port or a universal serial bus (USB). A graphics subsystem may also be connected to the system bus 1021. A monitor or other type of display device may also connected to the system bus 1021 via an interface, such as output interface 1050, which may in turn communicate with video memory. In addition to a monitor, computer 1010 may also include other peripheral output devices, which may be connected through output interface 1050.

The computer 1010 operates in a networked or distributed environment using logical connections to one or more other remote computers, such as remote computer 1070, which may in turn have capabilities different from device 1010. The logical connections depicted in FIG. 10 include a network 1071. The network 1071 can include both the wireless network described herein as well as other networks, such a local area network (LAN) or wide area network (WAN).

When used in a LAN networking environment, the computer 1010 is connected to the LAN through a network interface or adapter. When used in a WAN networking environment, the computer 1010 typically includes a communications component, such as a modem, or other means for establishing communications over the WAN, such as the Internet. A communications component, such as a network interface card, which may be internal or external, may be connected to the system bus 1021 via the user input interface of input 1040, or other appropriate mechanism. In a networked environment, program modules depicted relative to the computer 1010, or portions thereof, may be stored in a remote memory storage device.

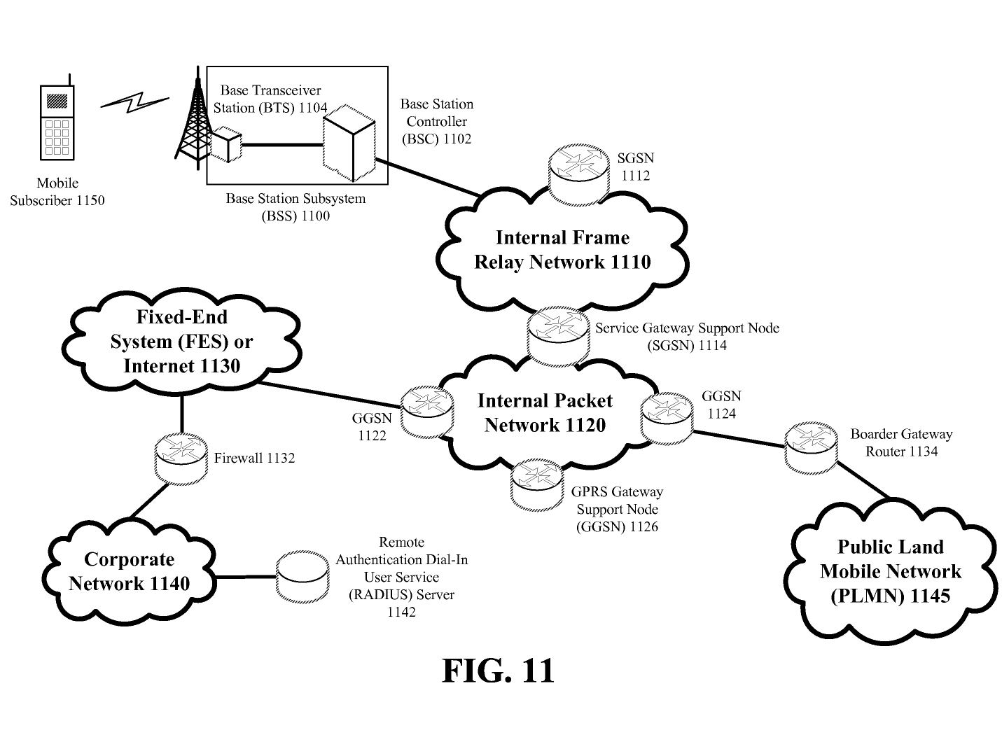

Turning now to FIG. 11, an overview of a network environment in which the claimed subject matter can be implemented is illustrated. The above-described systems and methodologies for channel estimation in MIMO wireless networks may be applied to any wireless communication network; however, the following description sets forth an exemplary, non-limiting operating environment for said systems and methodologies. The below-described operating environment should be considered non-exhaustive, and thus the below-described network architecture is merely an example of a network architecture into which the claimed subject matter can be incorporated. It is to be appreciated that the claimed subject matter can be incorporated into any now existing or future alternative architectures for communication network(s as well. For example, the described signal detection can be done for wireless LANs that use MIMO technology.

FIG. 11 depicts an overall block diagram of an exemplary network environment that the MIMO wireless network may be a part of. Such an environment can include a plurality of Base Station Subsystems (BSS) 1100 (only one is shown), each of which can comprise a Base Station Controller (BSC) 1102 serving one or more Base Transceiver Stations (BTS) such as BTS 1104. BTS 1104 can serve as an access point where mobile device with multiple antennas (e.g., mobile subscriber devices 1150) become connected to the MIMO-based wireless network.

In one example, packet traffic originating from mobile subscriber 1150 is transported over the air interface to a BTS 1104, and from the BTS 1104 to the BSC 1102. Base station subsystems, such as BSS 1100, can be a part of internal frame relay network 1110 that can include Service GPRS Support Nodes (“SGSN”) such as SGSN 1112 and 1114. Each SGSN is in turn connected to an internal packet network 1120 through which a SGSN 1112, 1114, etc., can route data packets to and from a plurality of gateway GPRS support nodes (GGSN) 1122, 1124, 1126, etc. As illustrated, SGSN 1114 and GGSNs 1122, 1124, and 1126 are part of internal packet network 1120. Gateway GPRS serving nodes 1122, 1124 and 1126 can provide an interface to external Internet Protocol (“IP”) networks such as Public Land Mobile Network (“PLMN”) 1145, corporate intranets 1140, or Fixed-End System (“FES”) or the public Internet 1130. As illustrated, subscriber corporate network 1140 can be connected to GGSN 1122 via firewall 1132; and PLAIN 1145 can be connected to GGSN 1124 via boarder gateway router 1134. The Remote Authentication Dial-In User Service (“RADIUS”) server 1142 may also be used for caller authentication when a user of a mobile subscriber device 1150 calls corporate network 1140.

Generally, there can be four different cell sizes—macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A method in a multiple-input multiple-output (MIMO)-based wireless network, the method comprising:
receiving a training signal from a MIMO-based wireless network, the training signal comprising a set of at least one of loosely synchronized (LS) codes or shifted LS codes; and
estimating channel state information (CSI) for at least one channel based at least in part on the training sequence.

2. The method of claim 1 wherein the receiving comprises receiving a training signal comprising a set of LS codes.

3. The method of claim 1 wherein the receiving comprises receiving a training signal comprising a set of shifted LS codes.

4. The method of claim 1 wherein the estimating of the CSI comprises employing a Golay correlator optimized for speed.

5. The method of claim 1 wherein the estimating of the CSI comprises employing an Golay correlator optimized for efficiency.

6. The method of claim 1 wherein the receiving comprises receiving a training signal from a wireless network that is at least one of a cellular-based network or a wireless LAN.

7. The method of claim 1 wherein the receiving comprises receiving a training signal from a MIMO intersymbol interference (ISI) network.

8. A computer-readable medium containing instructions that when executed performs the method of:
determining a training sequence of at least one of loosely synchronized (LS) codes or shifted LS codes;
transmitting the training sequence over a multiple-input multiple-output (MIMO) wireless network; and
receiving an indication of a precoder scheme from a remote MIMO device, the precoder scheme based on estimated channel state information (CSI) determined by the training sequences.

9. The computer-readable medium of claim 8 wherein the determining of a training sequence of at least one of loosely synchronized (LS) codes or shifted LS codes includes determining LS codes.

10. The computer-readable medium of claim 8 wherein the determining wherein the determining of a training sequence of at least one of loosely synchronized (LS) codes or shifted LS codes includes determining shifted LS codes.

11. The computer-readable medium of claim 8 wherein the receiving of an indication of a precoder scheme from a remote MIMO device comprises receiving an indication of a precoder scheme from at least one of an access point or a base station.

12. The computer-readable medium of claim 8 wherein the transmitting of the training sequence over a MIMO wireless network comprises transmitting the training sequence over a MIMO intersymbol interference (ISI) network.

13. The computer-readable medium of claim 8 wherein the transmitting of the training sequence over a MIMO wireless network comprises transmitting the training sequence over at least one of a MIMO wireless LAN or cellular network.

14. The computer-readable medium of claim 8 wherein the transmitting of the training sequence over a MIMO wireless network comprises transmitting a frame comprising a preamble and a postamble.

15. The computer-readable medium of claim 8 wherein the determining a training sequence of at least one of loosely synchronized (LS) codes or shifted LS codes comprises employing at least one of fast Golay correlator or an efficient Golay correlator.

16. A apparatus used in a multiple-input, multiple-output (MIMO) network comprising:
a memory;
a plurality of antennas;
a channel estimation component that receives a training signal from at least some of the plurality of antennas comprising at least one of loosely synchronized (LS) codes or shifted loosely synchronized codes and estimates the channel state information (CSI) based at least in part on the training signal.

17. The apparatus of claim 16 further comprising an efficient Golay correlator component that performs efficient Golay correlation while facilitating the channel estimation component in estimating the CSI.

18. The apparatus of claim 16 further comprising a fast Golay component that performs efficient Golay correlation while facilitating the channel estimation component in estimating the CSI.

19. The apparatus of claim 16 further comprising a precoder component that uses the estimated CSI to determine a precoding scheme.

20. The apparatus of claim 16 wherein the apparatus is at least one of a mobile phone, a laptop, or a wireless network interface card.
